(19) United States
(12) Patent Application Publication
(10) Pub. No.: US 2009/0105523 A1
(43) Pub. Date: Apr. 23, 2009

(54) SYSTEMS AND METHODS FOR COMPLIANCE MONITORING

(75) Inventors: Reza Kassayan, Atherton, CA (US); Bao Tran, San Jose, CA (US); Amir Abolfathi, Woodside, CA (US)

Correspondence Address: LEVINE BAGADE HAN LLP, 2483 EAST BAYSHORE ROAD, SUITE 100, PALO ALTO, CA, 94303, US

(73) Assignee: Sonitus Medical, Inc., Menlo Park, CA (US)

(21) Appl. No.: 11/874,847

(22) Filed: Oct. 18, 2007

(51) Int. Cl. H04R 25/00; G08B 5/22

(52) U.S. Cl. 600/25; 340/693.1

(57) ABSTRACT

Systems and methods are disclosed for determining compliance for a treatment device powered by an energy storage device by determining an average power consumption of the treatment device and a power capacity of the energy storage device; determining a start time and a stop time for using the energy storage device; determining usage based on the power capacity and the average power consumption; and determining compliance as a function of the usage, start time and stop time. In another aspect, the compliance monitoring device monitors sound delivery as a measure of compliance.

### BACKGROUND

For many dental and medical treatment processes, it is often advantageous for professionals to be able to measure elapsed time of operation of the treating equipment. Particularly in medicine, it is useful for a doctor to know how well a patient is complying with a prescribed regimen of treatment in order to be able to judge the treatment's efficiency.

A typical compliance monitor system might consist of a treatment detector, a treatment time counter, and a readout device. These are used, respectfully, to detect that a treatment is being used in an acceptable fashion, to count the time interval of the treatment, and to display and clear the treatment time counter reading.

When the readout device is separate from the treatment time counter, which is often the case in portable treatment devices, it is necessary to provide means of connecting the two in order to utilize the display and clear functionality. It is often desired to minimize the number of signal lines used for such connection for reasons of cost, size, and reliability.

There are prior references which discuss methods of storing and retrieving data related to a patient's use of a medical device. Petrofsky, U.S. Pat. No. 4,642,769, entitled METHOD AND APPARATUS FOR PROVIDING STIMULATED EXERCISE OF PARALYZED LIMBS, discloses a computer controlled system for controlling precise movement of paralyzed muscles through electrical stimulation. A physician programs a memory cartridge which is used by the patient at remotely located and computer controlled exercise equipment. The cartridge stores records of the intensity and length of a work out. The cartridge can record specific exercise data, such as a leg lift count, by incrementing the data in a memory location each time the leg is lifted. The exercise is automatically terminated after the count exceeds a prescribed maximum number. The physician can recall the data directly from the cartridge.

Kipnis, U.S. Pat. No. 4,738,268, entitled RELATIVE CLOCK TIME, discloses a time clock for determining the relative time between two or more events independently of wall clock time. Each time a patient begins recording data, stops recording data, or presses a separate button to indicate the patient believes a certain event is taking place, a time stamp is added to the data. This data is then recorded as digital information. After the recording is complete, the data is transferred to a physician through a modem.

Ogren, U.S. Pat. No. 4,817,044. entitled COLLECTION AND REPORTING SYSTEM FOR MEDICAL APPLIANCES, discloses a data collection and reporting system for medical appliances. The system includes a usage monitor device which is attached to a host medical instrument. The meter automatically logs clock times when the instrument is turned on or off. The meter includes an electronical flag indicator which indicates meter overflow. The meter flashes the flag indicator at a six month point to indicate the need for preventative maintenance. A portable data collector collects the data from the monitoring device through an eight pin telephone type cable.

Maher et al., U.S. Pat. No. 4,832,033, entitled ELECTRICAL STIMULATION OF MUSCLE, discloses an electrical stimulation system having a system controller and a personal, portable stimulator unit. The stimulator unit is programmed to store in its memory the characteristics of the applied stimulation patterns and a record of the number of times that the patient has applied them. Maher et al. discloses several interfaces between the system controller and the personal unit. In each of these configurations, the information is stored and transferred as a digital word.

Fabian et al., U.S. Pat. No. 5,233.987, entitled SYSTEM AND METHOD FOR MONITORING PATIENT'S COMPLIANCE, discloses monitoring of medical patient's compliance with a prescribed regimen of treatment through elapsed time of equipment operation. A treatment device used by the patient applies a stimulation signal to the patient through an electrode and counts a first clock signal which produces a first count indicative of the length of time which the stimulation signal is applied. When the patient revisits the doctor, a compliance monitor readout device is connected to the treatment device to facilitate the compliance monitoring. The treatment device then counts, in response to second clock signal generated by the compliance monitor, from the first count to a second predetermined count. The compliance monitor readout device also counts the second clock signal and produces a third count. The compliance monitor readout device then displays an output as a function of the third count.

Dunstan, U.S. Pat. No. 5,565.759, entitled SMART BATTERY PROVIDING BATTERY LIFE AND RECHARGE TIME PREDICTION, discloses a smart battery that can predict the remaining life and recharge time of the battery based on battery-specific characteristics. A memory stores battery-specific characteristics, such as charge characteristics, discharge characteristics, capacity characteristics, and self-discharge characteristics. The environmental conditions of the battery, such as temperature, and battery current (charge or discharge) are measured. A microcontroller periodically determines an incremental self-discharge of the battery based on the measured environmental conditions and the self-discharge characteristic of the battery. The microcontroller predicts the remaining battery life of the battery based on the remaining capacity of the battery, the environmental conditions of the battery, and a selected discharge rate of the battery. The discharge rate can be selected by a user, a power management system or by other means. A charge rate of the battery can also be selected. The microcontroller predicts the recharge time of the battery based on the selected charge rate, the present battery capacity, one or more charging characteristics of the battery, and the environmental conditions of the battery (such as battery temperature).

### SUMMARY

Systems and methods are disclosed for determining compliance for a treatment device powered by an energy storage device by determining an average power consumption of the treatment device and a power capacity of the energy storage device; determining a start time and a stop time for using the energy storage device; determining usage based on the power capacity and the average power consumption; and determining compliance as a function of the usage, start time and stop time.

In another aspect, systems and methods are disclosed for monitoring compliance by monitoring sub-categories of hearing frequency ranges and measure the amount of energy delivered in each sub-category and sum the delivered energy to determine the total effective sound delivery.

Implementations of the above aspect may include one or more of the following. The system sub-categorizes hearing frequency range of human into several non-linear frequency ranges and call them S1 to Sn. Each subcategory S has a range and a median frequency called median frequencies F1 to Fn respective to S1 to Sn. A “weight” for each S category called W1 to Wn can be used. The amount of energy delivered (E) to patient in each S subcategory in electronic section is recorded and E is the integration of sound levels in each subcategory over time. In each point of time the system can calculate the total effective sound delivery (TESD) to the patient as TESD=E1*F1*W1+ . . . +En*Fn*Wn

The system provides a compliance monitoring means which is retained on the individual and thus is less subject to destruction, loss, forgetfulness, or any of the numerous other problems. The compliance information helps the patient, treating professionals, and any other stakeholders to assist the patient in properly using the appliance in a timely manner. The system can accumulate delivered energy over time as an indicator for patient's compliance. The information can be displayed as a number, or can be displayed relative to an expected number that clinician specifies can be used in Patient Control Unit display to acknowledge patient of his or her compliance. In case of relative number it can be a 0 to 100% for ease of understanding.

### BRIEF DESCRIPTION OF THE DRAWINGS

FIG. 1A shows an exemplary process for monitoring compliance.

FIG. 1B shows an exemplary process for monitoring compliance.

FIG. 1C shows an exemplary process for monitoring compliance.

FIG. 1D shows another exemplary process for monitoring compliance.

FIG. 1E illustrates the dentition of a patient's teeth and one variation of a two-way communication device which is removably placed upon or against the patient's tooth or teeth as a removable oral appliance.

FIG. 2A illustrates a perspective view of the lower teeth showing one exemplary location for placement of the removable oral appliance two-way communication device.

FIG. 2B illustrates another variation of the removable oral appliance in the form of an appliance which is placed over an entire row of teeth in the manner of a mouthguard.

FIG. 2C illustrates another variation of the removable oral appliance which is supported by an arch.

FIG. 2D illustrates another variation of an oral appliance configured as a mouthguard.

FIG. 3 illustrates a detail perspective view of the oral appliance positioned upon the patient's teeth utilizable in combination with a transmitting assembly external to the mouth and wearable by the patient in another variation of the device.

FIG. 4 shows an illustrative configuration of the individual components in a variation of the oral appliance device having an external transmitting assembly with a receiving and transducer assembly within the mouth.

FIG. 5 shows an illustrative configuration of another variation of the device in which the entire assembly is contained by the oral appliance within the user's mouth.

FIG. 6A shows a partial cross-sectional view of an oral appliance placed upon a tooth with an electronics/transducer assembly adhered to the tooth surface via an adhesive.

FIG. 6B shows a partial cross-sectional view of a removable backing adhered onto an adhesive surface.

FIG. 7 shows a partial cross-sectional view of another variation of an oral appliance placed upon a tooth with an electronics/transducer assembly pressed against the tooth surface via an osmotic pouch.

FIG. 8 shows a partial cross-sectional view of another variation of an oral appliance placed upon a tooth with an electronics/transducer assembly pressed against the tooth surface via one or more biasing elements.

FIG. 9 illustrates another variation of an oral appliance having an electronics assembly and a transducer assembly separated from one another within the electronics and transducer housing of the oral appliance.

FIGS. 10 and 11 illustrate additional variations of oral appliances in which the electronics and transducer assembly are maintainable against the tooth surface via a ramped surface and a biasing element.

FIG. 12 shows yet another variation of an oral appliance having an interfacing member positioned between the electronics and/or transducer assembly and the tooth surface.

FIG. 13 shows yet another variation of an oral appliance having an actuatable mechanism for urging the electronics and/or transducer assembly against the tooth surface.

FIG. 14 shows yet another variation of an oral appliance having a cam mechanism for urging the electronics and/or transducer assembly against the tooth surface.

FIG. 15 shows yet another variation of an oral appliance having a separate transducer mechanism positionable upon the occlusal surface of the tooth for transmitting vibrations.

FIG. 16 illustrates another variation of an oral appliance having a mechanism for urging the electronics and/or transducer assembly against the tooth surface utilizing a bite-actuated mechanism.

FIG. 17 shows yet another variation of an oral appliance having a composite dental anchor for coupling the transducer to the tooth.

FIGS. 18A and 18B show side and lop views, respectively, of an oral appliance variation having one or more transducers which may be positioned over the occlusal surface of the tooth.

FIGS. 19A and 19B illustrate yet another variation of an oral appliance made from a shape memory material in its pre-Formed relaxed configuration and its deformed configuration when placed over or upon the patient's tooth, respectively, to create an interference fit.

FIG. 20 illustrates yet another variation of an oral appliance made from a pre-formed material in which the transducer may be positioned between the biased side of the oral appliance and the tooth surface.

FIG. 21 illustrates a variation in which the oral appliance may be omitted and the electronics and/or transducer assembly may be attached to a composite dental anchor attached directly to the tooth surface.

FIGS. 22A and 22B show partial cross-sectional side and perspective views, respectively, of another variation of an oral appliance assembly having its occlusal surface removed or omitted for patient comfort.

FIGS. 23A and 23B illustrate perspective and side views, respectively, of an oral appliance which may be coupled to a screw or post implanted directly into the underlying bone, such as the maxillary or mandibular bone.

FIG. 24 illustrates another variation in which the oral appliance may be coupled to a screw or post implanted directly into the palate of a patient.

FIGS. 25A and 25B illustrate perspective and side views, respectively, of an oral appliance which may have its transducer assembly or a coupling member attached to the gingival surface to conduct vibrations through the gingival tissue and underlying bone.

FIG. 26 illustrates an example of how multiple oral appliance two-way communication assemblies or transducers may be placed on multiple teeth throughout the patient's mouth.

FIGS. 27A and 27B illustrate perspective and side views, respectively, of an oral appliance (similar to a variation shown above) which may have a microphone unit positioned adjacent to or upon the gingival surface to physically separate the microphone from the transducer to attenuate or eliminate feedback.

FIG. 28 illustrates another variation of a removable oral appliance supported by an arch and having a microphone unit integrated within the arch.

FIG. 29 shows yet another variation illustrating at least one microphone and optionally additional microphone units positioned around the user's mouth and in wireless communication with the electronics and/or transducer assembly.

### DESCRIPTION

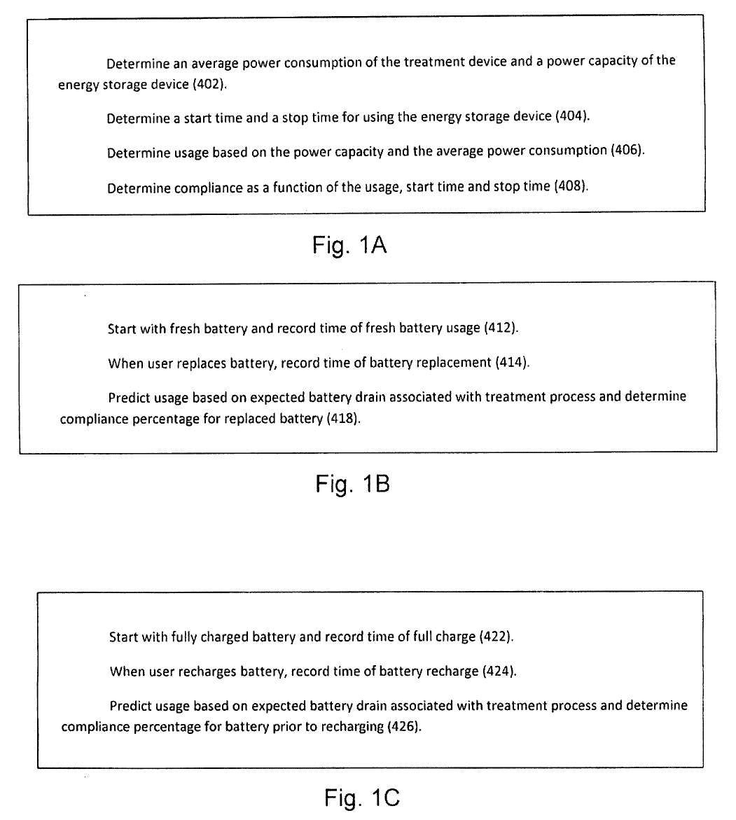

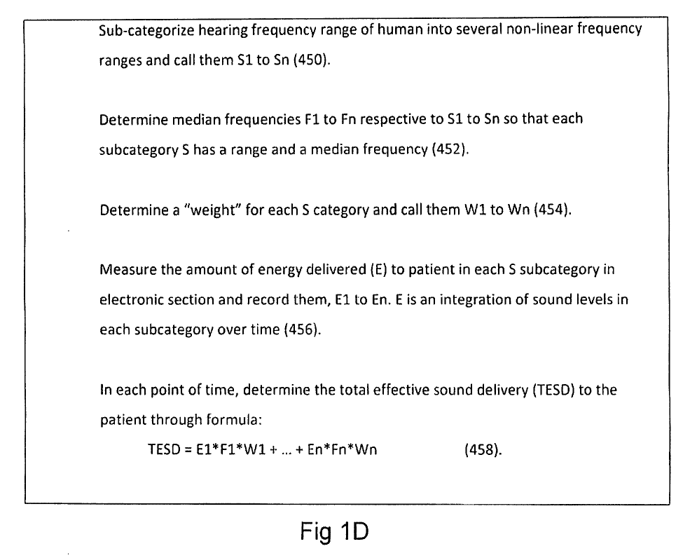

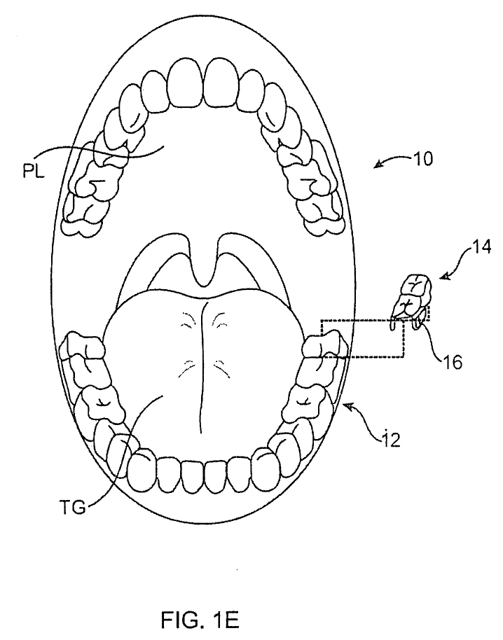

As shown in FIG. 1A, an exemplary process to monitor compliance based on measurements from an energy storage device (such as a battery) is shown. The process determines an average power consumption of the treatment device and a power capacity of the energy storage device (402). The process then determines a start time and a stop time for using the energy storage device (404). Next, device usage is determined based on the power capacity and the average power consumption (406). The process then determines compliance as a function of the usage, start time and stop time (408). This information can be supplied to the patient or the treating professional for monitoring compliance. Pseudo code for the process of FIG. 1A is as follows:

Determine an average power consumption of the treatment device and a power capacity of the energy storage device (402)

Determine a start time and a stop time for using the energy storage device (404)

Determine usage based on the power capacity and the average power consumption (406)

Determine compliance as a function of the usage, start time and stop time (408)

Turning now to FIG. 1B, an exemplary process for monitoring compliance using disposable batteries is shown. In this process, the patient or user inserts a fresh battery and the processor records the time of fresh battery insertion (412). When user replaces the battery, the system then records the time of battery replacement (414). Next, the system predicts usage based on expected battery drain associated with treatment process and determine compliance percentage for replaced battery (418). Pseudo code for the process of FIG. 1B is as follows:

Start with fresh battery and record time of fresh battery usage (412)

When user replaces battery, record time of battery replacement (4 14)

Predict usage based on expected battery drain associated with treatment process and determine compliance percentage for replaced battery (418)

Referring now to FIG. 1C, the system starts with fully charged battery and record time of full charge (422). When user recharges battery, the system records the time of battery recharge (424). The system predicts usage based on expected battery drain associated with treatment process and determines compliance percentage for battery prior to recharging (426).). Pseudo code for the process of FIG. 1C is as follows:

Start with fully charged battery and record time of full charge (422)

When user recharges battery, record time of battery recharge (424)

Predict usage based on expected battery drain associated with treatment process and determine compliance percentage for battery prior to recharging (426)

The battery can be a smart battery which is a rechargeable battery that is equipped with electronics to provide present capacity and charging information about the battery to system host and smart battery charger. The electronics can be embedded in the battery pack, or exist outside the battery pack. Wherever located, the electronics must be able to measure the environmental conditions of the smart battery. Smart battery maintains information regarding its environment, charging characteristics, discharge characteristics, self-discharge characteristics, capacity characteristics, present capacity, and total capacity. This battery-specific information may be stored with, or separate from, smart battery, but must be battery-specific. Typically the battery-specific information is maintained within smart battery. The characteristics stored may be functions of temperature, battery current, battery voltage, environmental conditions, or other variables affecting battery performance. The battery characteristics may be stored in the form of tables, formulas, or algorithms that represent the characteristics of the battery. Environmental information tracked by smart battery may include battery temperature, humidity, air pressure, or other conditions that influence battery performance and/or capacity. Smart battery may also include programmable alarm values for events, such as over-charge, over-voltage, over-temperature, temperature increasing too rapidly, remaining run-time and remaining capacity.

Based on the battery-specific characteristics, measured environmental conditions, measured battery current, and battery history (battery capacity can be affected by the charge/discharge history of the battery), smart battery can accurately determine present battery capacity. Based on the present battery capacity, smart battery can predict remaining battery run-time based on either the present discharge rate or a user-supplied discharge rate. Similarly, smart battery can determine whether an amount of power can be supplied. The amount of power can either be a total amount of power or an amount of power in addition to that already being supplied by the smart battery. Similarly, smart battery can also determine its optimal charging voltage and charging current. In summary, based on battery-specific characteristics, measured battery conditions, and present battery capacity, smart battery can accurately determine remaining battery life, power availability, and optimal charging conditions. Smart battery 34 can provide this information to the system host and the smart battery charger to provide users with useful battery information, improve system power management, optimize battery charging, and maximize battery life. More information on the battery life and recharge time prediction is discussed in U.S. Pat. No. 5,565,759, the content of which is incorporated by reference.

In another embodiment, the system can monitor the battery's voltage curve as a measure of remaining capacity. In another embodiment, the system can monitor the battery current level as a proxy for remaining capacity. In the voltage curve embodiment, the system takes a one-time, full cycle, voltage measurement of a constant load, and uses it to transform the partial voltage curve of the current workload into a form with robust predictability. Based on the transformed history curve, a statistical method is used to make a prediction of remaining capacity that can be used as part of the compliance prediction process.

FIG. 1D shows another exemplary process for monitoring compliance by monitoring sound. This embodiment is named TESD (total effective sound delivery). In this embodiment, the system sub categorizes hearing frequency range of human into several non-linear frequency ranges and call them S1 to Sn (450). In one embodiment, n is between five and eight. Each subcategory S has a range and a median frequency, and the system determines median frequencies F1 to Fn respective to S1 to Sn (452). Next, the system specifies a “weight” for each S category and call them W1 to Wn (454). Weights are by the default 1 and the weight may change them later based on clinical trials. The system then measures the amount of energy delivered (E) to patient in each S subcategory in electronic section and record them, E1 to En (456). E is an integration of sound levels in each subcategory over time. For each point of time the system calculates the total effective sound delivery (TESD) to the patient through this formula:

TESD=E1*F1*W1+ . . . +En*Fn*Wn (458)

TESD can be accumulated over time as an indicator for patient's compliance. TESD itself or relative to an expected number that clinician specifies can be used in Patient Control Unit display to acknowledge patient of his or her compliance. In case of relative number it can be a 0 to 100% for ease of understanding.

The pseudo-code for TESD is as follows:

Sub-categorize hearing frequency range of human into several non-linear frequency ranges and call them S1 to Sn (450).

Determine median frequencies F1 to Fn respective to S1 to Sn so that each subcategory S has a range and a median frequency (452)

Determine a “weight” for each S category and call them W1 to Wn (454).

Measure the amount of energy delivered (E) to patient in each S subcategory in electronic section and record them. E1 to En. E is an integration of sound levels in each subcategory over time (456)

In each point of time, determine the total effective sound delivery (TESD) to the patient through formula:

TESD=E1*F1*W1+ . . . +En*Fn*Wn (458)

TESD can be scaled as a relative number between 0 and 100 to provide an expected number for each patient and can be adjusted to be between the 0 to 100 range (Relative TESD). Such relative TESD scaled number provides an indicator of patient exposure to die sound delivered by the system.

The above monitoring device can be used with a treatment device such as a device for treating tinnitus, stuttering, and hearing problems. In one embodiment, the treatment device provides an electronic and transducer device that can be attached, adhered, or otherwise embedded into or upon a removable oral appliance or other oral device to form a two-way communication assembly. In another embodiment, the device 1 provides an electronic and transducer device that can be attached, adhered, or otherwise embedded into or upon a removable oral appliance or other oral device to form a medical tag containing patient identifiable information. Such an oral appliance may be a custom-made device fabricated from a thermal forming process utilizing a replicate model of a dental structure obtained by conventional dental impression methods. The electronic and transducer assembly may receive incoming sounds either directly or through a receiver to process and amplify the signals and transmit the processed sounds via a vibrating transducer element coupled to a tooth or other bone structure, such as the maxillary, mandibular, or palatine bone structure.

Turning now to more details on the device 1, as shown in FIG. 1E, a patient's mouth and dentition 10 is illustrated showing one possible location for removably attaching two-way communication assembly 14 upon or against at least one tooth, such as a molar 12. The patient's tongue TG and palate PL are also illustrated for reference. An electronics and/or transducer assembly 16 may be attached, adhered, or otherwise embedded into or upon the assembly 14, as described below in further detail.

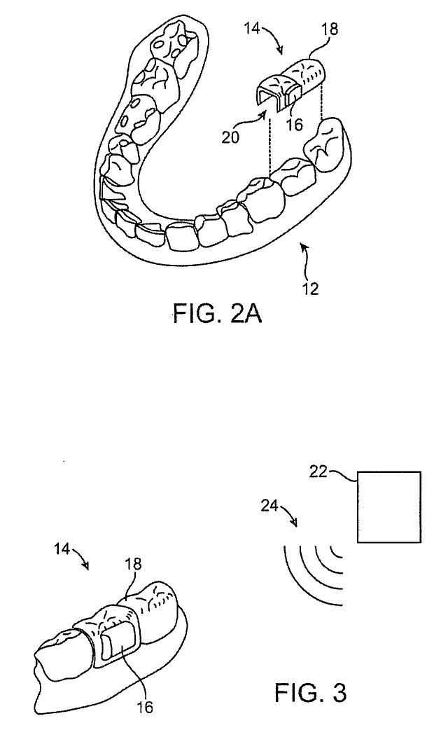

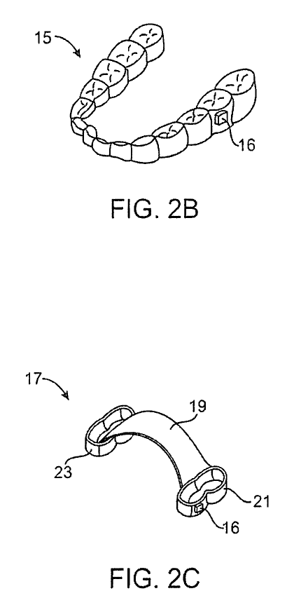

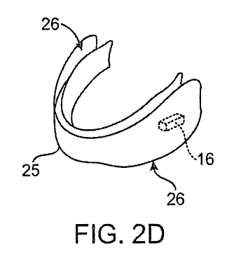

FIG. 2A shows a perspective view of the patient's lower dentition illustrating the two-way communication assembly 14 comprising a removable oral appliance 18 and the electronics and/or transducer assembly 16 positioned along a side surface of the assembly 14. In this variation, oral appliance 18 may be fitted upon two molars 12 within tooth engaging channel 20 defined by oral appliance 18 for stability upon the patient's teeth, although in other variations, a single molar or tooth may be utilized. Alternatively, more than two molars may be utilized for the oral appliance 18 to be attached upon or over. Moreover, electronics and/or transducer assembly 16 is shown positioned upon a side surface of oral appliance 18 such that the assembly 16 is aligned along a buccal surface of the tooth 12; however, other surfaces such as the lingual surface of the tooth 12 and other positions may also be utilized. The figures are illustrative of variations and are not intended to be limiting; accordingly, other configurations and shapes for oral appliance 18 are intended to be included herein.

FIG. 2B shows another variation of a removable oral appliance in the form of an appliance 15 which is placed over an entire row of teeth in the manner of a mouthguard. In this variation, appliance 15 may be configured to cover an entire bottom row of teeth or alternatively an entire upper row of teeth. In additional variations, rather than covering the entire rows of teeth, a majority of the row of teeth may be instead be covered by appliance 15. Assembly 16 may be positioned along one or more portions of the oral appliance 15.

FIG. 2C shows yet another variation of an oral appliance 17 having an arched configuration. In this appliance, one or more tooth retaining portions 21, 23, which in this variation may be placed along the upper row of teeth, may be supported by an arch 19 which may lie adjacent or along the palate of the user. As shown, electronics and/or transducer assembly 16 may be positioned along one or more portions of the tooth retaining portions 21, 23. Moreover, although the variation shown illustrates an arch 19 which may cover only a portion of the palate of the user, other variations may be configured to have an arch which covers the entire palate of the user.

FIG. 2D illustrates yet another variation of an oral appliance in the form of a mouthguard or retainer 25 which may be inserted and removed easily from the user's mouth. Such a mouthguard or retainer 25 may be used in sports where conventional mouthguards are worn; however, mouthguard or retainer 25 having assembly 16 integrated therein may be utilized by persons, hearing impaired or otherwise, who may simply hold the mouthguard or retainer 25 via grooves or channels 26 between their teeth for receiving instructions remotely and communicating over a distance.

Generally, the volume of electronics and/or transducer assembly 16 may be minimized so as to be unobtrusive and as comfortable to the user when placed in the mouth. Although the size may be varied, a volume of assembly 16 may be less than 800 cubic millimeters. This volume is, of course, illustrative and not limiting as size and volume of assembly 16 and may be varied accordingly between different users.

Moreover, removable oral appliance 18 may be fabricated from various polymeric or a combination of polymeric and metallic materials using any number of methods, such as computer-aided machining processes using computer numerical control (CNC) systems or three-dimensional printing processes, e.g., stereolithography apparatus (SLA), selective laser sintering (SLS), and/or other similar processes utilizing three-dimensional geometry of the patient's dentition, which may be obtained via any number of techniques. Such techniques may include use of scanned dentition using intra-oral scanners such as laser, white light, ultrasound, mechanical three-dimensional touch scanners, magnetic resonance imaging (MRI), computed tomography (CT), other optical methods, etc.

In forming the removable oral appliance 18, the appliance 18 may be optionally formed such that it is molded to fit over the dentition and at least a portion of the adjacent gingival tissue to inhibit the entry of food, fluids, and other debris into the oral appliance 18 and between the transducer assembly and tooth surface. Moreover, the greater surface area of the oral appliance 18 may facilitate the placement and configuration of the assembly 16 onto the appliance 18.

Additionally, the removable oral appliance 18 may be optionally fabricated to have a shrinkage factor such that when placed onto the dentition, oral appliance 18 may be configured to securely grab onto the tooth or teeth as the appliance 18 may have a resulting size slightly smaller than the scanned tooth or teeth upon which the appliance 18 was formed. The fitting may result in a secure interference fit between the appliance 18 and underlying dentition.

In one variation, with assembly 14 positioned upon the teeth, as shown in FIG. 3, an extra-buccal transmitter assembly 22 located outside the patient's mouth may be utilized to receive auditory signals for processing and transmission via a wireless signal 24 to the electronics and/or transducer assembly 16 positioned within the patient's mouth, which may then process and transmit the processed auditory signals via vibratory conductance to the underlying tooth and consequently to the patient's inner ear.

The transmitter assembly 22, as described in further detail below, may contain a microphone assembly as well as a transmitter assembly and may be configured in any number of shapes and forms worn by the user, such as a watch, necklace, lapel, phone, belt-mounted device, etc.

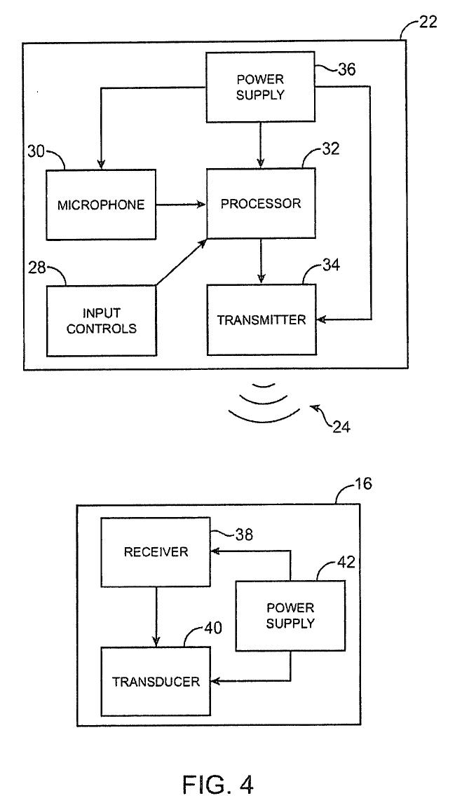

FIG. 4 illustrates a schematic representation of one variation of two-way communication assembly 14 utilizing an extra-buccal transmitter assembly 22, which may generally comprise microphone 30 for receiving sounds and which is electrically connected to processor 32 for processing the auditory signals. Processor 32 may be connected electrically to transmitter 34 for transmitting the processed signals to the electronics and/or transducer assembly 16 disposed upon or adjacent to the user's teeth. The microphone 30 and processor 32 may be configured to detect and process auditory signals in any practicable range, but may be configured in one variation to detect auditory signals ranging from, e.g., 250 Hertz to 20,000 Hertz.

With respect to microphone 30, a variety of various microphone systems may be utilized. For instance, microphone 30 may be a digital, analog, and/or directional type microphone. Such various types of microphones may be interchangeably configured to be utilized with the assembly, if so desired.

Power supply 36 may be connected to each of the components in transmitter assembly 22 to provide power thereto. The transmitter signals 24 may be in any wireless form utilizing, e.g., radio frequency, ultrasound, microwave. Blue Tooth® (BLUETOOTH SIC, INC., Bellevue, Wash.), etc. for transmission to assembly 16. Assembly 22 may also optionally include one or more input controls 28 that a user may manipulate to adjust various acoustic parameters of the electronics and/or transducer assembly 16, such as acoustic focusing, volume control, filtration, muting, frequency optimization, sound adjustments, and tone adjustments, etc.

The signals transmitted 24 by transmitter 34 may be received by electronics and/or transducer assembly 16 via receiver 38, which may be connected to an internal processor for additional processing of the received signals. The received signals may be communicated to transducer 40, which may vibrate correspondingly against a surface of the tooth to conduct the vibratory signals through the tooth and bone and subsequently to the middle ear to facilitate hearing of the user. Transducer 40 may be configured as any number of different vibratory mechanisms. For instance, in one variation, transducer 40 may be an electromagnetically actuated transducer. In other variations, transducer 40 may be in the form of a piezoelectric crystal having a range of vibratory frequencies, e.g., between 250 to 4000 Hz.

Power supply 42 may also be included with assembly 16 to provide power to the receiver, transducer, and/or processor, if also included. Although power supply 42 may be a simple battery, replaceable or permanent, other variations may include a power supply 42 which is charged by inductance via an external charger. Additionally, power supply 42 may alternatively be charged via direct coupling to an alternating current (AC) or direct current (DC) source. Other variations may include a power supply 42 which is charged via a mechanical mechanism, such as an internal pendulum or slidable electrical inductance charger as known in the art, which is actuated via, e.g., motions of the jaw and/or movement for translating the mechanical motion into stored electrical energy for charging power supply 42.

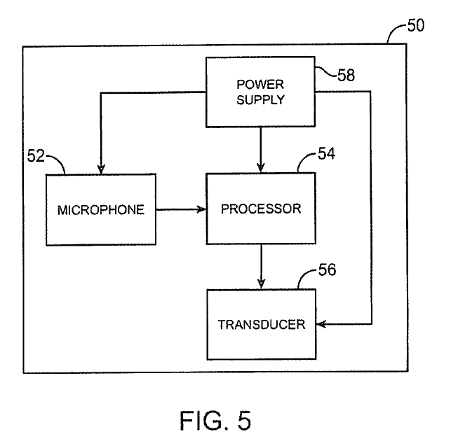

In another variation of assembly 16, rather than utilizing an extra-buccal transmitter, two-way communication assembly 50 may be configured as an independent assembly contained entirely within the user's mouth, as shown in FIG. 5. Accordingly, assembly 50 may include an internal microphone 52 in communication with an on-board processor 54. Internal microphone 52 may comprise any number of different types of microphones, as described above. Processor 54 may be used to process any received auditory signals for filtering and/or amplifying the signals and transmitting them to transducer 56, which is in vibratory contact against the tooth surface. Power supply 58, as described above, may also be included within assembly 50 for providing power to each of the components of assembly 50 as necessary.

In order to transmit the vibrations corresponding to the received auditory signals efficiently and with minimal loss to the tooth or teeth, secure mechanical contact between the transducer and the tooth is ideally maintained to ensure efficient vibratory communication. Accordingly, any number of mechanisms may be utilized to maintain this vibratory communication.

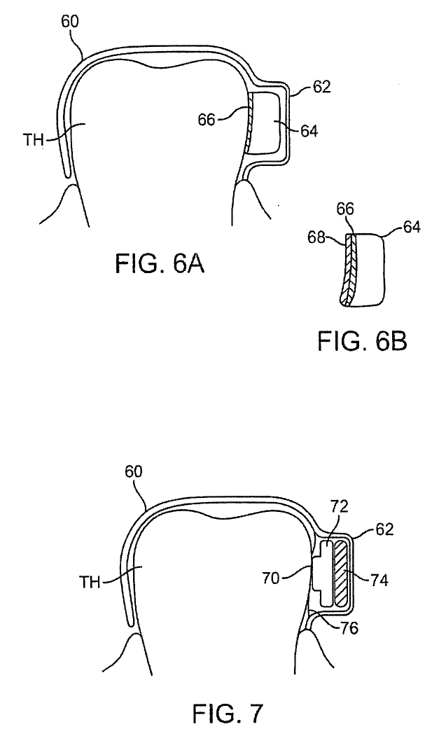

In one variation as shown in FIG. 6A, a partial cross-sectional view of a removable oral appliance 60 is shown placed over or upon a tooth TH. Electronics and/or transducer housing 62 may be seen defined along oral appliance 60 such that housing 62 is aligned or positioned adjacent to a side surface, buccal and/or lingual surface, of the tooth TH. Housing 62 may provide protection to the electronics and/or transducer assembly from the environment of the mouth.

An electronics and/or transducer assembly 64 may be simply placed, embedded, or encapsulated within housing 62 for contacting the tooth surface. In this variation, assembly 64 may be adhered against the tooth surface via an adhesive surface or film 66 such that contact is maintained between the two. As shown in FIG. 6B, a removable backing 68 may be adhered onto adhesive surface 66 and removed prior to placement upon the tooth surface. In this manner, assembly 64 may be replaced upon the tooth as necessary with additional electronics and/or transducer assemblies.

Aside from an adhesive film 66, another alternative may utilize an expandable or swellable member to ensure a secure mechanical contact of the transducer against the tooth. As shown in FIG. 7, an osmotic patch or expandable hydrogel 74 may be placed between housing 62 and electronics and/or transducer assembly 72. After placement of oral appliance 60, hydrogel 74 may absorb some fluids, either from any surrounding fluid or from a fluid introduced into hydrogel 74, such that hydrogel 74 expands in size to force assembly 72 into contact against the tooth surface. Assembly 72 may be configured to define a contact surface 70 having a relatively smaller contact area to facilitate uniform contact of the surface 70 against the tooth. Such a contact surface 70 may be included in any of the variations described herein. Additionally, a thin encapsulating layer or surface 76 may be placed over housing 62 between contact surface 70 and the underlying tooth to prevent any debris or additional fluids from entering housing 62.

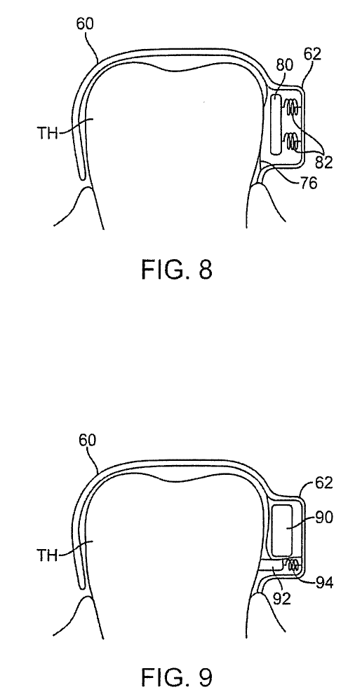

Another variation is shown in FIG. 8, which shows electronics and/or transducer assembly 80 contained within housing 62. In this variation, one or more biasing elements 82, e.g., springs, pre-formed shape memory elements, etc., may be placed between assembly 80 and housing 62 to provide a pressing force on assembly 80 to urge the device against the underlying tooth surface, thereby ensuring mechanical contact.

In yet another variation, the electronics may be contained as a separate assembly 90 which is encapsulated within housing 62 and the transducer 92 may be maintained separately from assembly 90 but also within housing 62. As shown in FIG. 9. transducer 92 may be urged against the tooth surface via a spring or other biasing element 94 and actuated via any of the mechanisms described above.

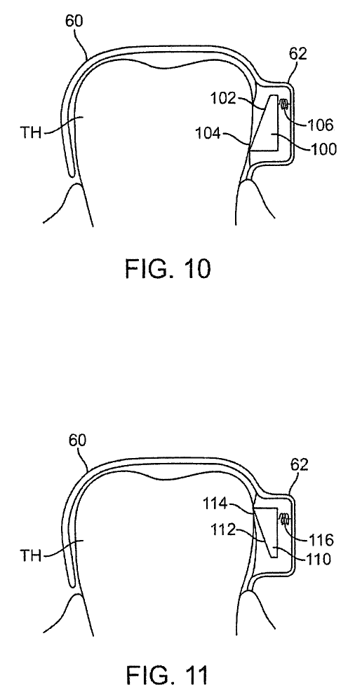

In other variations as shown in FIG. 10, electronics and/or transducer assembly 100 may be configured to have a ramped surface 102 in apposition to the tooth surface. The surface 102 may be angled away from the occlusal surface of the tooth. The assembly 100 may be urged via a biasing element or spring 106 which forces the ramped surface 102 to pivot about a location 104 into contact against the tooth to ensure contact for the transducer against the tooth surface.

FIG. 11 illustrates another similar variation in electronics and/or transducer assembly 110 also having a ramped surface 112 in apposition to the tooth surface. In this variation, the ramped surface 112 may be angled towards the occlusal surface of the tooth. Likewise, assembly 110 may be urged via a biasing element or spring 116 which urges the assembly 110 to pivot about its lower end such that the assembly 110 contacts the tooth surface at a region 114.

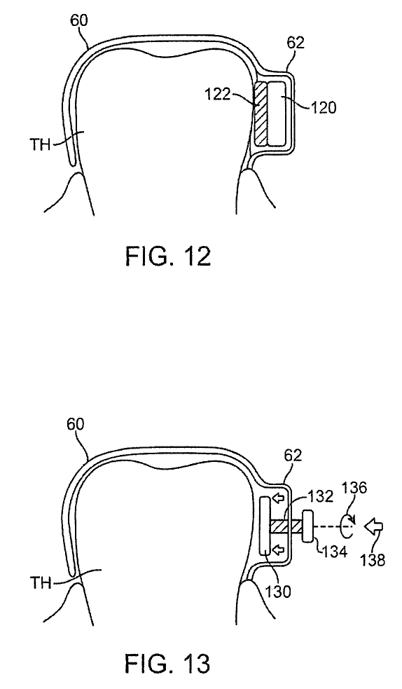

In yet another variation shown in FIG. 12, electronics and/or transducer assembly 120 may be positioned within housing 62 with an interface layer 122 positioned between the assembly 120 and the tooth surface. Interface layer 122 may be configured to conform against the tooth surface and against assembly 120 such that vibrations may be transmitted through layer 122 and to the tooth in a uniform manner. Accordingly, interface layer 122 may be made from a material which attenuates vibrations minimally. Interface layer 122 may be made in a variety of forms, such as a simple insert, an O-ring configuration, etc. or even in a gel or paste form, such as denture or oral paste, etc. Additionally, layer 122 may be fabricated from various materials, e.g., hard plastics or polymeric materials, metals, etc.

FIG. 13 illustrates yet another variation in which electronics and/or transducer assembly 130 may be urged against the tooth surface via a mechanical mechanism. As shown, assembly 130 may be attached to a structural member 132, e.g., a threaded member or a simple shaft, which is connected through housing 62 to an engagement member 134 located outside housing 62. The user may rotate engagement member 134 (as indicated by rotational arrow 136) or simply push upon member 134 (as indicated by linear arrow 138) to urge assembly 130 into contact against the tooth. Moreover, actuation of engagement member 134 may be accomplished manually within the mouth or through the user's cheek or even through manipulation via the user's tongue against engagement member 134.

Another variation for a mechanical mechanism is illustrated in FIG. 14. In this variation, electronics and/or transducer assembly 140 may define a portion as an engaging surface 142 for contacting against a cam or lever mechanism 144. Cam or lever mechanism 144 may be configured to pivot 146 such that actuation of a lever 148 extending through housing 62 may urge cam or lever mechanism 144 to push against engaging surface 142 such that assembly 140 is pressed against the underlying tooth surface.

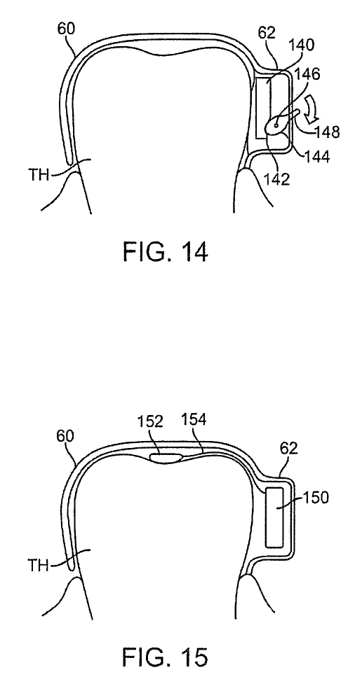

In yet another variation, the electronics 150 and the transducer 152 may be separated from one another such that electronics 150 remain disposed within housing 62 but transducer 152, connected via wire 154, is located beneath dental oral appliance 60 along an occlusal surface of the tooth, as shown in FIG. 15. In such a configuration, vibrations are transmitted via the transducer 152 through the occlusal surface of the tooth. Additionally, the user may bite down upon the oral appliance 60 and transducer 152 to mechanically compress the transducer 152 against the occlusal surface to further enhance the mechanical contact between the transducer 152 and underlying tooth to further facilitate transmission therethrough.

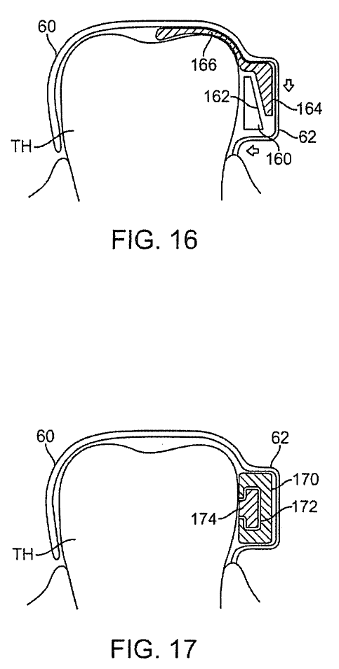

In the variation of FIG. 16, another example for a bite-enhanced coupling mechanism is illustrated where electronics and/or transducer assembly 160 defines an angled interface surface 162 in apposition to a correspondingly angled engaging member 164. A proximal end of engaging member 164 may extend through housing 62 and terminate in a pusher member 166 positioned over an occlusal surface of the tooth TH. Once oral appliance 60 is initially placed over tooth TH, the user may bite down or otherwise press down upon the top portion of oral appliance 60, thereby pressing down upon pusher member 166 which in turn pushes down upon engaging member 164, as indicated by the arrow. As engaging member 164 is urged downwardly towards the gums, its angled surface may push upon the corresponding and oppositely angled surface 162 to urge assembly 160 against the tooth surface and into a secure mechanical contact.

In yet another variation, an electronics and/or transducer assembly 170 may define a channel or groove 172 along a surface for engaging a corresponding dental anchor 174, as shown in FIG. 17. Dental anchor 174 may comprise a light-curable acrylate-based composite material adhered directly to the tooth surface. Moreover dental anchor 174 may be configured in a shape which corresponds to a shape of channel or groove 172 such that the two may be interlined in a mating engagement. In this manner, the transducer in assembly 170 may vibrate directly against dental anchor 174 which may then transmit these signals directly into the tooth TH.

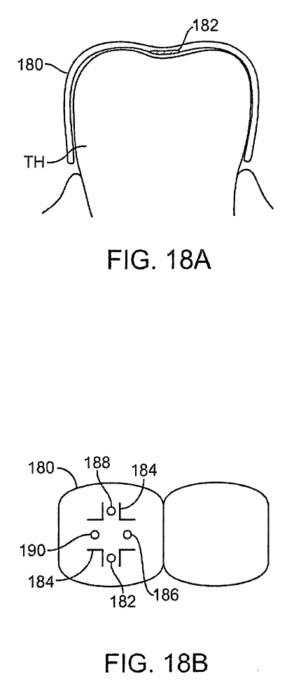

FIGS. 18A and 18B show partial cross-sectional side and top views, respectively, of another variation in which oral appliance 180 may define a number of channels or grooves 184 along a top portion of oral appliance 180. Within these channels or grooves 184, one or more transducers 182, 186, 188, 190 may be disposed such that they are in contact with the occlusal surface of the tooth and each of these transducers may be tuned to transmit frequencies uniformly. Alternatively, each of these transducers may be tuned to transmit only at specified frequency ranges. Accordingly, each transducer can be programmed or preset for a different frequency response such that each transducer may be optimized for a different frequency response and/or transmission to deliver a relatively high-fidelity sound to the user.

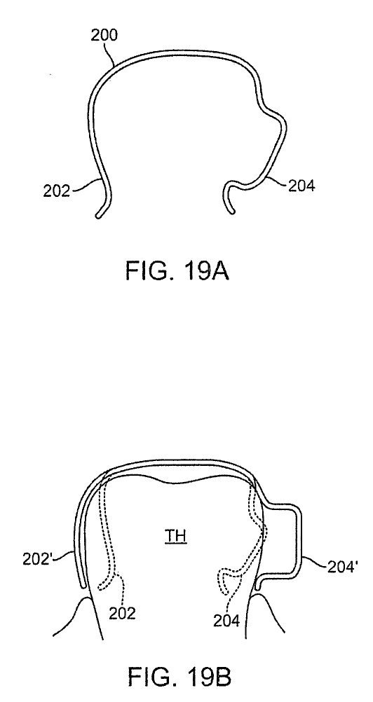

In yet another variation, FIGS. 19A and 19B illustrate an oral appliance 200 which may be pre-formed from a shape memory polymer or alloy or a superelastic material such as a Nickel-Titanium alloy, e.g., Nitinol. FIG. 19A shows oral appliance 200 in a first configuration where members 202, 204 arc in an unbiased memory configuration. When placed upon or against the tooth TH, members 202, 204 may be deflected into a second configuration where members 202′, 204′ are deformed to engage tooth TH in a secure interference fit, as shown in FIG. 19B. The biased member 204′ may be utilized to press the electronics and/or transducer assembly contained therein against the tooth surface as well as to maintain securement of the oral appliance 200 upon the tooth TH.

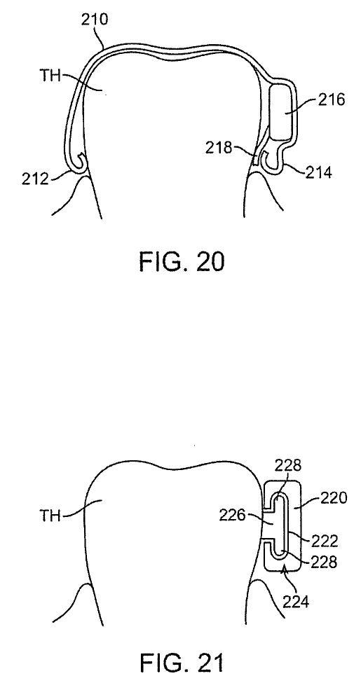

Similarly, as shown in FIG. 20, removable oral appliance 210 may have biased members to secure engage the tooth TH, as above. In this variation, the ends of the members 212, 214 may be configured into curved portions under which a transducer element 218 coupled to electronics assembly 216 may be wedged or otherwise secured to ensure mechanical contact against the tooth surface.

FIG. 21 shows yet another variation in which the oral appliance is omitted entirely. Mere, a composite dental anchor or bracket 226, as described above, may be adhered directly onto the tooth surface. Alternatively, bracket 226 may be comprised of a biocompatible material, e.g., stainless steel, Nickel-Titanium, Nickel, ceramics, composites, etc., formed into a bracket and anchored onto the tooth surface. The bracket 226 may be configured to have a shape 228 over which an electronics and/or transducer assembly 220 may be slid over or upon via a channel 222 having a corresponding receiving configuration 224 for engagement with bracket 226. In this manner, assembly 220 may be directly engaged against bracket 226, through which a transducer may directly vibrate into the underlying tooth TH. Additionally, in the event that assembly 220 is removed from the tooth TH, assembly 220 may be simply slid or rotated off bracket 226 and a replacement assembly may be put in its place upon bracket 226.

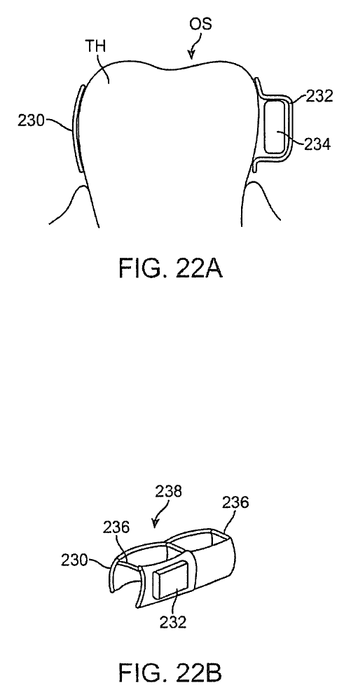

FIGS. 22A and 22B show partial cross-sectional side and perspective views, respectively, of yet another variation of an oral appliance 230. In this variation, the oral appliance 230 may be configured to omit an occlusal surface portion of the oral appliance 230 and instead engages the side surfaces of the tooth TH, such as the lingual and buccal surfaces only. The electronics and/or transducer assembly 234 may be contained, as above, within a housing 232 for contact against the tooth surface. Additionally, as shown in FIG. 22B, one or more optional cross-members 236 may connect the side portions of the oral appliance 230 to provide some structural stability when placed upon the tooth. This variation may define an occlusal surface opening 238 such that when placed upon the tooth, the user may freely bite down directly upon the natural occlusal surface of the tooth unobstructed by the oral appliance device, thereby providing for enhanced comfort to the user.

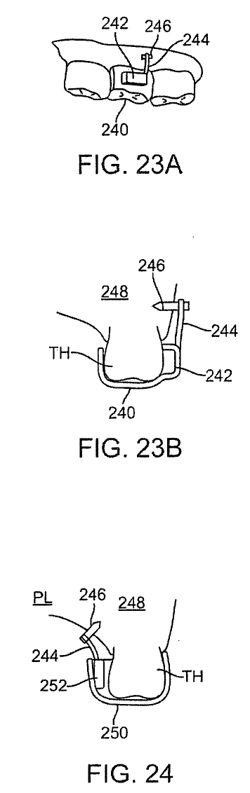

In yet other variations, vibrations may be transmitted directly into the underlying bone or tissue structures rather than transmitting directly through the tooth or teeth of the user. As shown in FIG. 23A, an oral appliance 240 is illustrated positioned upon the user's tooth, in this example upon a molar located along the upper row of teeth. The electronics and/or transducer assembly 242 is shown as being located along the buccal surface of the tooth. Rather than utilizing a transducer in contact with the tooth surface, a conduction transmission member 244, such as a rigid or solid metallic member, may be coupled to the transducer in assembly 242 and extend from oral appliance 240 to a post or screw 246 which is implanted directly into the underlying bone 248, such as the maxillary bone, as shown in the partial cross-sectional view of FIG. 23B. As the distal end of transmission member 244 is coupled directly to post or screw 246, the vibrations generated by the transducer may be transmitted through transmission member 244 and directly into post or screw 246, which in turn transmits the vibrations directly into and through the bone 248 for transmission to the user's inner ear.

FIG. 24 illustrates a partial cross-sectional view of an oral appliance 250 placed upon the user's tooth TH with the electronics and/or transducer assembly 252 located along the lingual surface of the tooth. Similarly, the vibrations may be transmitted through the conduction transmission member 244 and directly into post or screw 246, which in this example is implanted into the palatine bone PL. Other variations may utilize this arrangement located along the lower row of teeth for transmission to a post or screw 246 drilled into the mandibular bone.

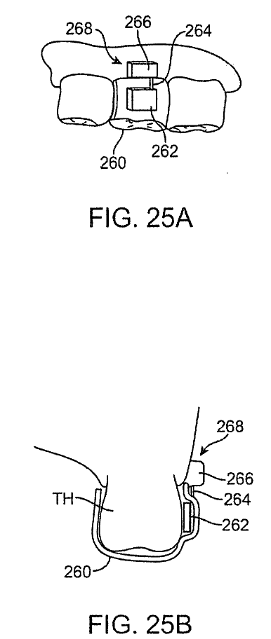

In yet another variation, rather utilizing a post or screw drilled into the underlying bone itself, a transducer may be attached, coupled, or otherwise adhered directly to the gingival tissue surface adjacent to the teeth. As shown in FIGS. 25A and 25B, an oral appliance 260 may have an electronics assembly 262 positioned along its side with an electrical wire 264 extending therefrom to a transducer assembly 266 attached to the gingival tissue surface 268 next to the tooth TH. Transducer assembly 266 may be attached to the tissue surface 268 via an adhesive, structural support arm extending from oral appliance 260, a dental screw or post, or any other structural mechanism. In use, the transducer may vibrate and transmit directly into the underlying gingival tissue, which may conduct the signals to the underlying bone.

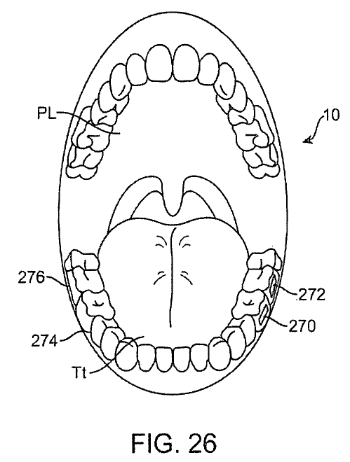

For any of the variations described above, they may be utilized as a single device or in combination with any other variation herein, as practicable, to achieve the desired hearing level in the user. Moreover, more than one oral appliance device and electronics and/or transducer assemblies may be utilized at any one time. For example, FIG. 26 illustrates one example where multiple transducer assemblies 270, 272, 274, 276 may be placed on multiple teeth. Although shown on the lower row of teeth, multiple assemblies may alternatively be positioned and located along the upper row of teeth or both rows as well. Moreover, each of the assemblies may be configured to transmit vibrations within a uniform frequency range. Alternatively in other variations, different assemblies may be configured to vibrate within non-overlapping frequency ranges between each assembly. As mentioned above, each transducer 270, 272, 274, 276 can be programmed or preset for a different frequency response such that each transducer may be optimized for a different frequency response and/or transmission to deliver a relatively high-fidelity sound to the user.

Moreover, each of the different transducers 270, 272, 274, 276 can also be programmed to vibrate in a manner which indicates the directionality of sound received by the microphone worn by the user. For example, different transducers positioned at different locations within the user's mouth can vibrate in a specified manner by providing sound or vibrational queues to inform the user which direction a sound was detected relative to an orientation of the user. For instance, a first transducer located, e.g., on a user's left tooth, can be programmed to vibrate for sound detected originating from the user's left side. Similarly, a second transducer located, e.g., on a user's right tooth, can be programmed to vibrate for sound detected originating from the user's right side. Other variations and queues may be utilized as these examples are intended to be illustrative of potential variations.

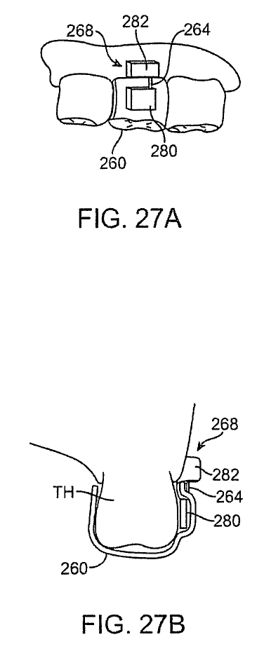

In variations where the one or more microphones are positioned in intra-buccal locations, the microphone may be integrated directly into the electronics and/or transducer assembly, as described above. However, in additional variation, the microphone unit may be positioned at a distance from the transducer assemblies to minimize feedback. In one example, similar to a variation shown above, microphone unit 282 may be separated from electronics and/or transducer assembly 280, as shown in FIGS. 27A and 27B. In such a variation, the microphone unit 282 positioned upon or adjacent to the gingival surface 268 may be electrically connected via wire(s) 264.

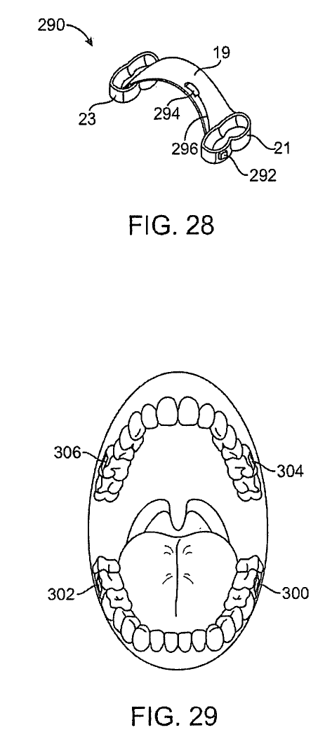

Although the variation illustrates the microphone unit 282 placed adjacent to the gingival tissue 268, unit 282 may be positioned upon another tooth or another location within the mouth. For instance, FIG. 28 illustrates another variation 290 which utilizes an arch 19 connecting one or more tooth retaining portions 21, 23, as described above. However, in this variation, the microphone unit 294 may be integrated within or upon the arch 19 separated from the transducer assembly 292. One or more wires 296 routed through arch 19 may electrically connect the microphone unit 294 to the assembly 292. Alternatively, rather than utilizing a wire 296, microphone unit 294 and assembly 292 may be wirelessly coupled to one another, as described above.

In yet another variation for separating the microphone from the transducer assembly, FIG. 29 illustrates another variation where at least one microphone 302 (or optionally any number of additional microphones 304, 306) may be positioned within the mouth of the user while physically separated from the electronics and/or transducer assembly 300. In this manner, the one or optionally more microphones 302, 304, 306 may be wirelessly coupled to the electronics and/or transducer assembly 300 in a manner which attenuates or eliminates feedback, if present, from the transducer.

The applications of the devices and methods discussed above are not limited to the treatment of hearing loss but may include any number of further treatment applications. Moreover, such devices and methods may be applied to other treatment sites within the body. Modification of the above-described assemblies and methods for carrying out the invention, combinations between different variations as practicable, and variations of aspects of the invention that are obvious to those of skill in the art are intended to be within the scope of the claims.

What is claimed is:

1. A method for determining compliance for a treatment device powered by an energy storage device, comprising:
a. measuring a power stored in the energy storage device; and
b. determining compliance based on the stored power of the energy storage device and an average power consumption for the treatment device.

2. The method of claim 1 comprising:
a. determining a start time and a stop time for using the energy storage device;
b. determining usage based on the stored power and the average power consumption; and
c. determining compliance as a function of the usage, start time and stop time.

3. The method of claim 1, wherein the energy storage device comprises a replaceable battery.

4. The method of claim 3, comprising determining the start time when the replaceable battery is first deployed.

5. The method of claim 3, comprising determining the stop time when the replaceable battery is replaced.

6. The method of claim 1, wherein the energy storage device comprises a rechargeable battery.

7. The method of claim 6, comprising determining the start time and a start power capacity of the rechargeable battery.

8. The method of claim 6, comprising determining the stop time and a remaining power capacity of the rechargeable battery.

9. The method of claim 1, comprising providing compliance information to one of: a patient, a treating professional, a designated monitoring agency.

10. The method of claim 1, comprising monitoring stuttering or tinnitus treatment.

11. An apparatus for transmitting vibrations via at least one tooth to facilitate communications, comprising:
a housing having a shape which is conformable to at least a portion of the at least one tooth;
an actuatable transducer disposed within or upon the housing and in vibratory communication with a surface of the at least one tooth; and
a compliance monitoring device coupled to the transducer.

12. The apparatus of claim 11 wherein the housing comprises an oral appliance having a shape which conforms to the at least one tooth.

13. The apparatus of claim 11 further comprising an electronic assembly disposed within or upon the housing and which is in communication with the transducer.

14. The apparatus of claim 11, wherein the compliance monitoring device measures a power stored in an energy storage device and determines compliance based on the stored power of the energy storage device and an average power consumption for the actuatable transducer.

15. The apparatus of claim 14, wherein the energy storage device comprises a replaceable battery.

16. The apparatus of claim 15, wherein the compliance monitoring device determines the start time when the replaceable battery is first deployed and determines the stop time when the replaceable battery is replaced.

17. The apparatus of claim 14, wherein the energy storage device comprises a rechargeable battery.

18. The apparatus of claim 17, wherein the compliance monitoring device determines the start time and a start power capacity of the rechargeable battery and the stop time and a remaining power capacity of the rechargeable battery.

19. The apparatus of claim 13 wherein the electronic assembly further comprises a processor in electrical communication with the transducer.

20. The apparatus of claim 19 wherein the electronic assembly further comprises a microphone for receiving auditory signals and which is in electrical communication with the processor.

21. The apparatus of claim 11 wherein the electronic assembly further comprises a receiver in wireless communication with an externally located transmitter assembly.

22. The apparatus of claim 11 further comprising at least one additional actuatable transducer in vibratory communication with the surface.

23. The apparatus of claim 22 wherein the compliance monitoring device monitors power consumption as a measure of compliance.

24. The apparatus of claim 22 wherein the compliance monitoring device monitors sound delivery as a measure of compliance.

25. A method for determining compliance for a treatment device, comprising:
a. measuring sound delivered by the treatment device; and
b. determining compliance based on the sound delivery by the treatment device.
